(19) United States
(12) Patent Application Publication
(10) Pub. No.: US 2026/0301718 A1
(43) Pub. Date: Oct. 1, 2026

(54) TUNING STABILISERS FOR STRINGED INSTRUMENT

(71) Applicant: Rui DINIS, Wallington (GB)

(72) Inventor: Rui DINIS, Wallington (GB)

(21) Appl. No.: 18/998,201

(22) PCT Filed: Jul. 26, 2023
(86) PCT No.: PCT/GB2023/051983

§ 371 Date: Jan. 24, 2025

(30) Foreign Application Priority Data
Jul. 26, 2022 (GB) 2210904.5

(51) Int. Cl. G10D 3/12; G10D 1/08

(52) U.S. Cl. CPC G10D 3/12; G10D 1/08

(57) ABSTRACT

A saddle block stabilising device for a guitar string comprising a saddle block having a first open bore suitable for providing a passage from the front of the guitar to the back of a guitar, and an intonation screw a locking screw having a cylindrical body with a threaded outer surface that cooperates with the second threaded bore; optionally, a threaded insert, and a second threaded bore, located either in the saddle block, or the threaded insert if present such that a guitar string may be fed across the second threaded bore or the threaded insert, and the locking screw inserted into the second threaded bore of the saddle block or on the threaded insert to secure the guitar string between a surface of the locking screw and a surface of the saddle block, the intonation screw or the threaded insert.

The present specification relates to tuning stabilisers for stringed instrument, that is, devices for ensuring that the tuned pitch of strings of a stringed instrument is retained.

A stringed instrument, such as a guitar, creates sounds through the vibration of the strings. The string is fixed at both ends by securement elements. Typically, the securement element at one end will be a rotatable tuning peg, by which means the tension in the string is adjusted until the desired frequency (also called ‘pitch’) of the ‘open’ string is achieved; the other end may or may not include a second means of adjusting either the length and/or tension. Over time however, the pitch of the string may drift due to the string slipping through the securement elements, or by movement of the securement elements. This problem is particularly acute when one of the securement elements is a tremolo block commonly used with electric guitars, whose position may be deliberately altered by the player using a tremolo arm to alter the pitch or add vibrato while playing; the guitar string may not return to its original position and tension due to the friction of the different parts, leaving the guitar out of tune.

The object of the present invention is to provide a system and devices which combined and/or separately aid in stabilising the pitch of the strings of a stringed instrument over time or during use.

According to the present invention, there is provided a stabilising device as defined in claim 1.

The overall philosophy of the invention is to provide a system where one or more (or all) strings are locked at two points, the tremolo bridge block or saddles, and the tuning pegs located in the guitar headstock, however, individual subsystems may be advantageously employed on their own or with further subsystems.

The invention will now be described, by way of example, with reference to the drawings, of which

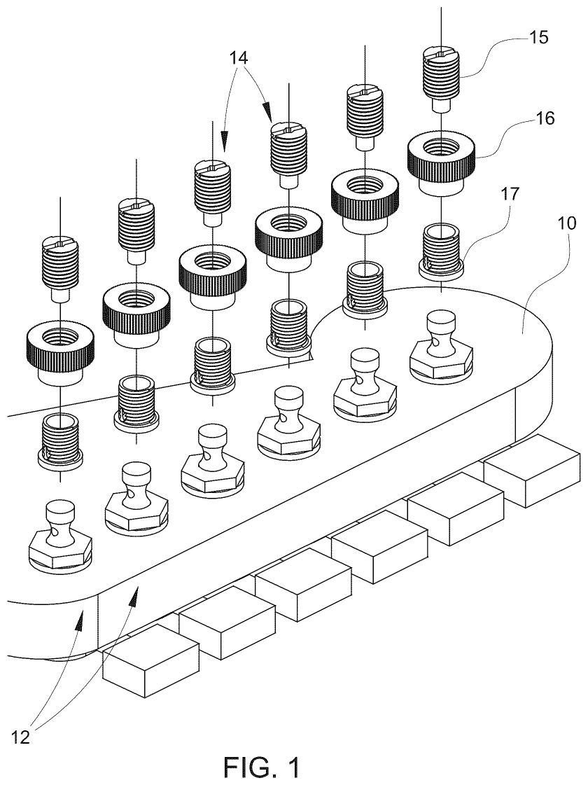

FIG. 1 is an exploded perspective view of a headstock stabilising device according to an embodiment of the invention;

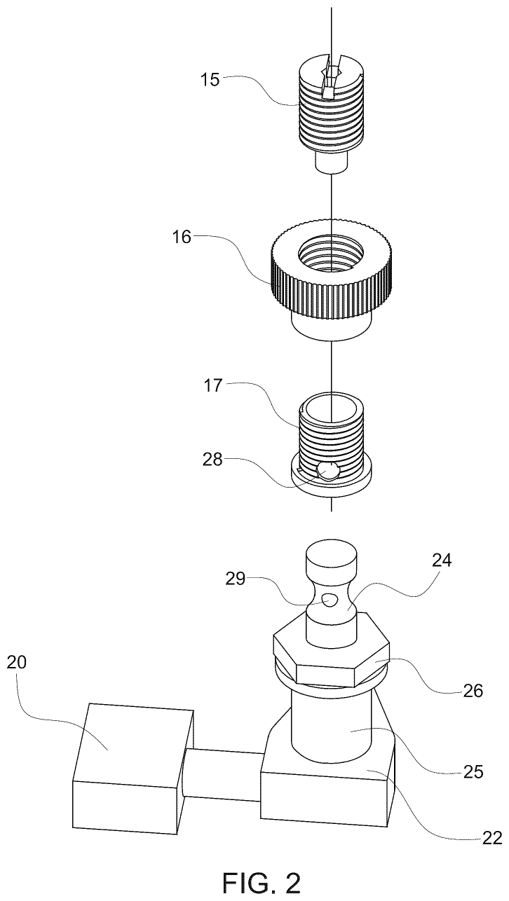

FIG. 2 is an exploded perspective view of a detail of the head headstock stabilising device;

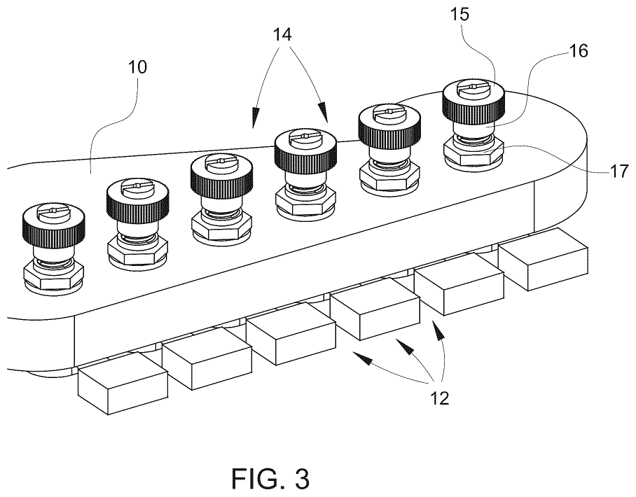

FIG. 3 is a perspective view of the assembled headstock stabilising device;

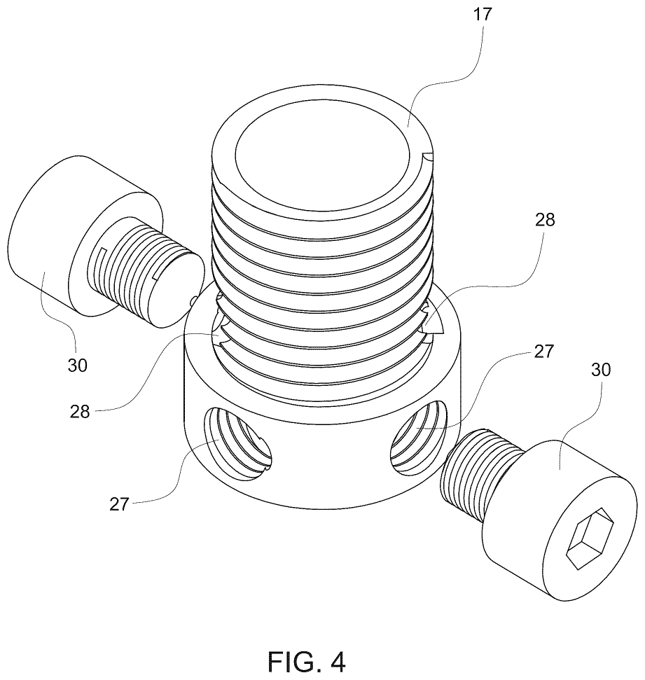

FIG. 4 is a perspective view of another embodiment of the part of the headstock stabilising device;

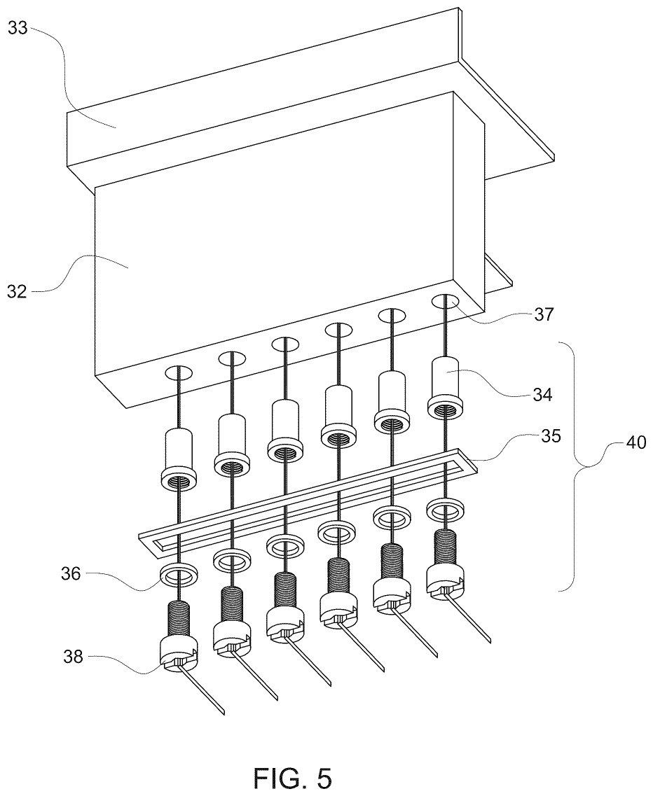

FIG. 5 is an exploded perspective view of a tremolo stabilising device according to an embodiment of the invention;

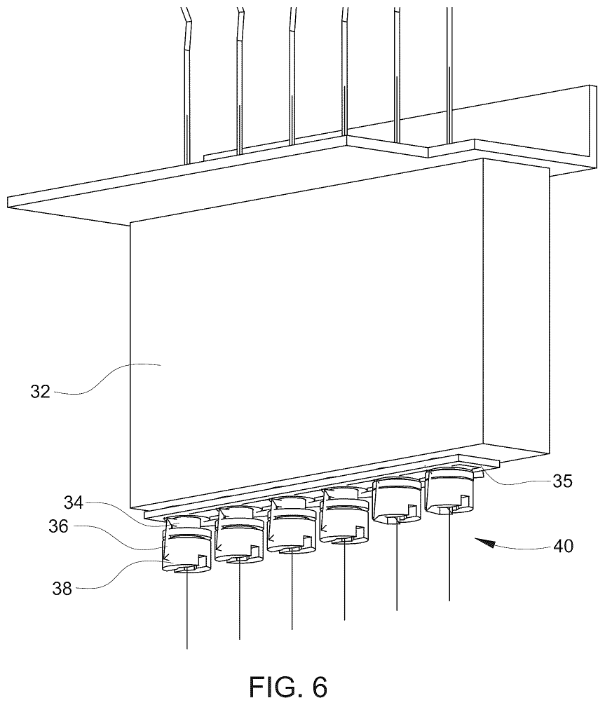

FIG. 6 is a perspective view of an assembled tremolo stabilising device;

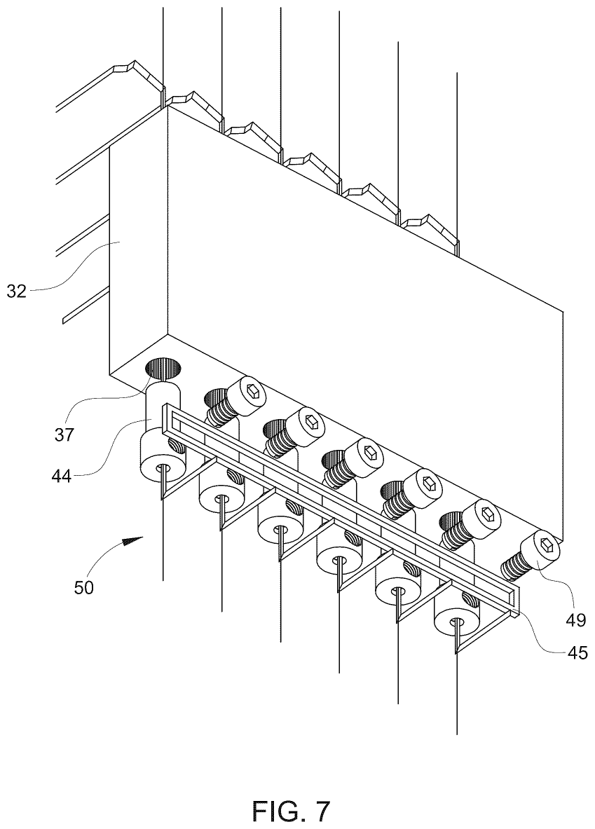

FIG. 7 is an exploded perspective view of another embodiment of a tremolo stabilising device;

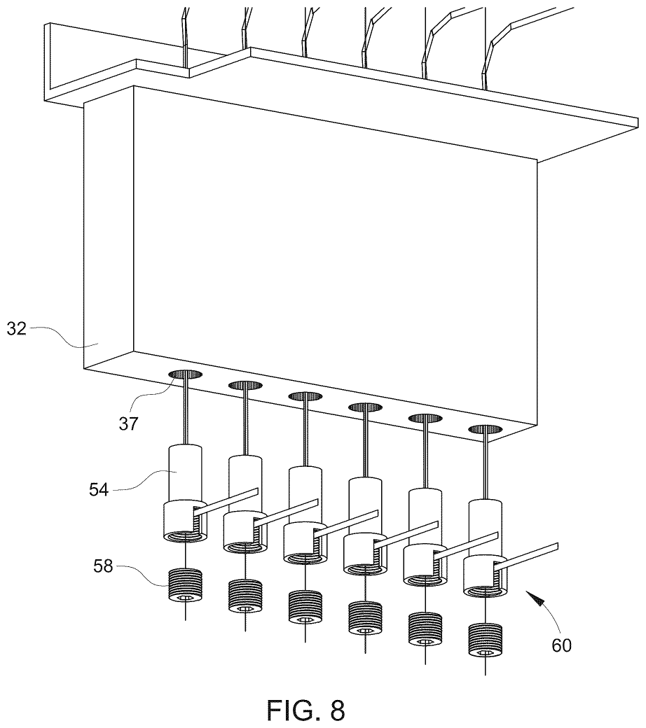

FIG. 8 is an exploded perspective view of another embodiment of a tremolo stabilising device;

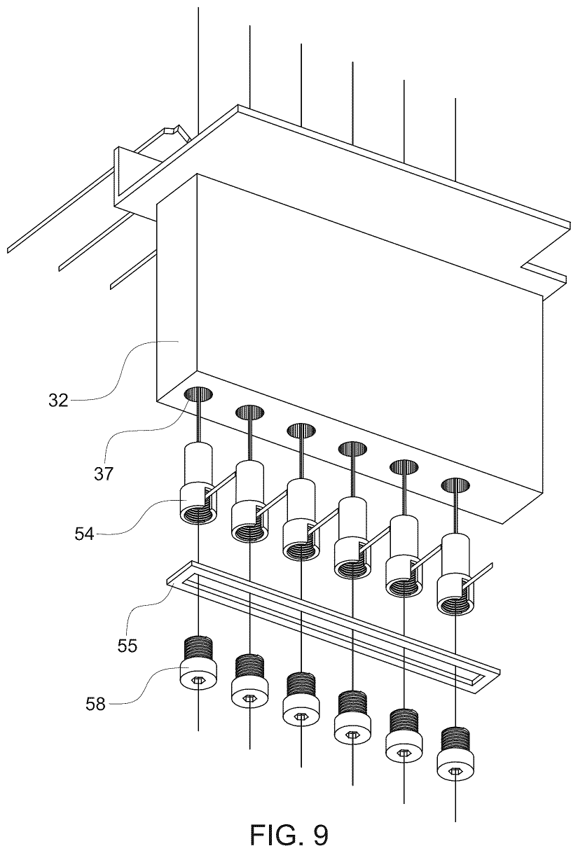

FIG. 9 is an exploded perspective view of another embodiment of a tremolo stabilising device;

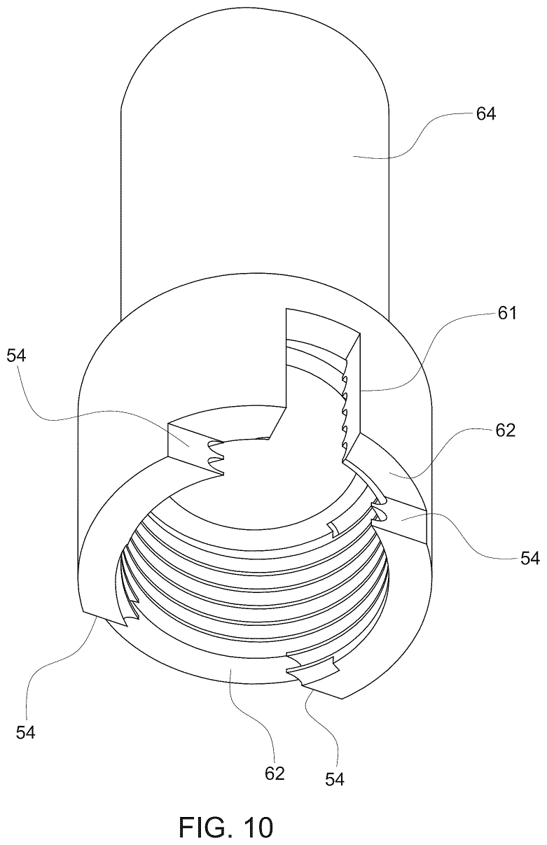

FIG. 10 is a perspective view of a detail of another embodiment of the tremolo stabilising device;

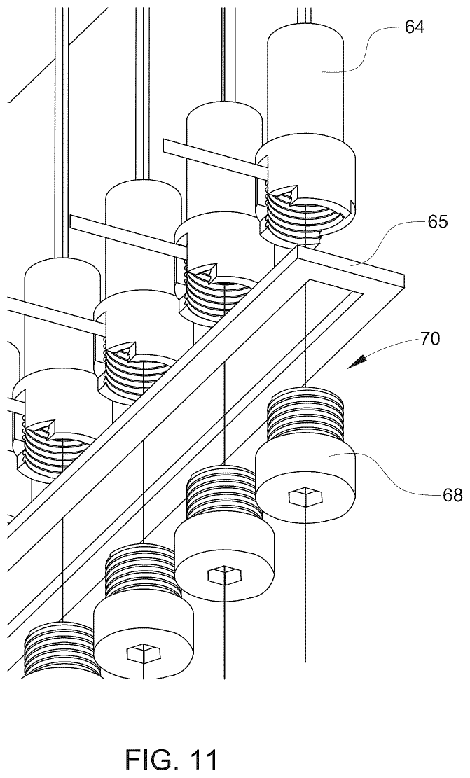

FIG. 11 is a perspective view of the component shown in FIG. 10 in use with the tremolo stabilising device;

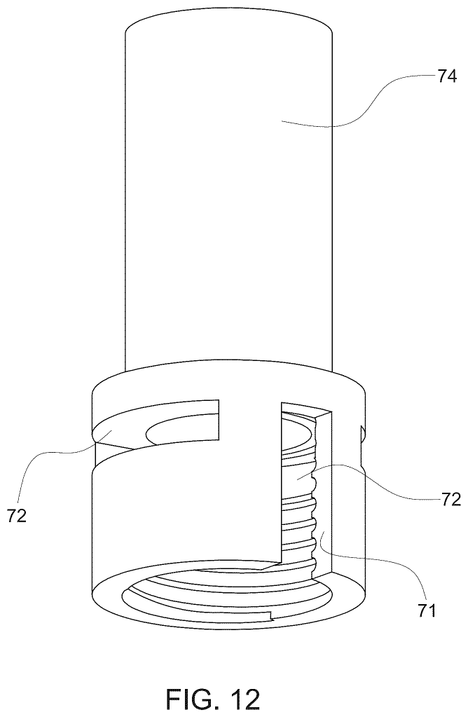

FIG. 12 is a perspective view of another embodiment of part of a tremolo stabilising device;

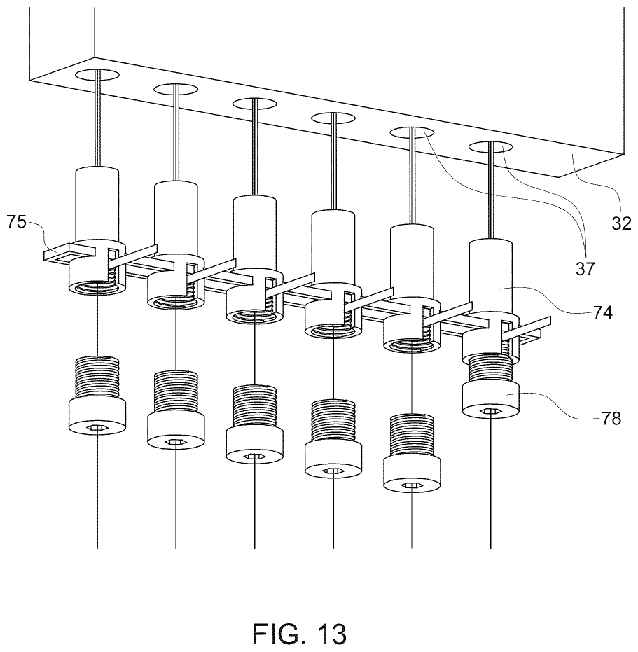

FIG. 13 is an exploded perspective view of a tremolo stabilising device of incorporating the part shown in FIG. 12;

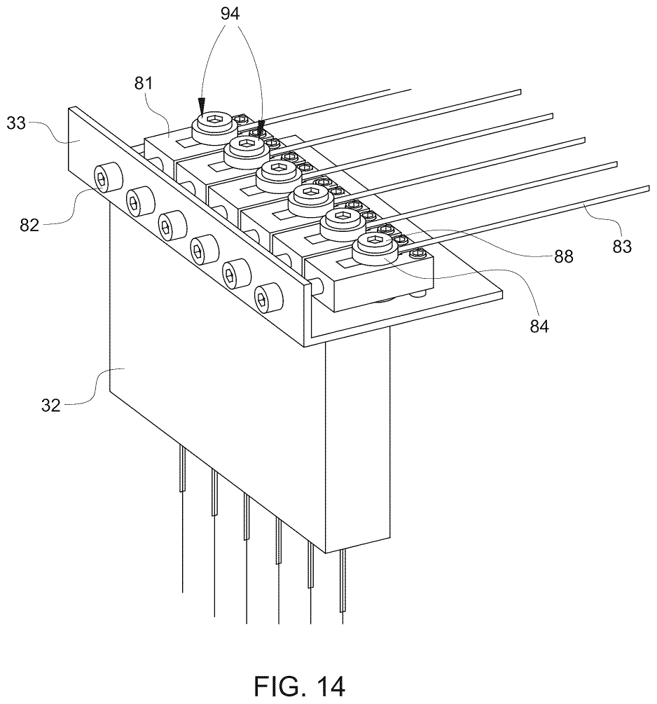

FIG. 14 is an exploded perspective view of a saddle block stabilising device according to an embodiment of the invention;

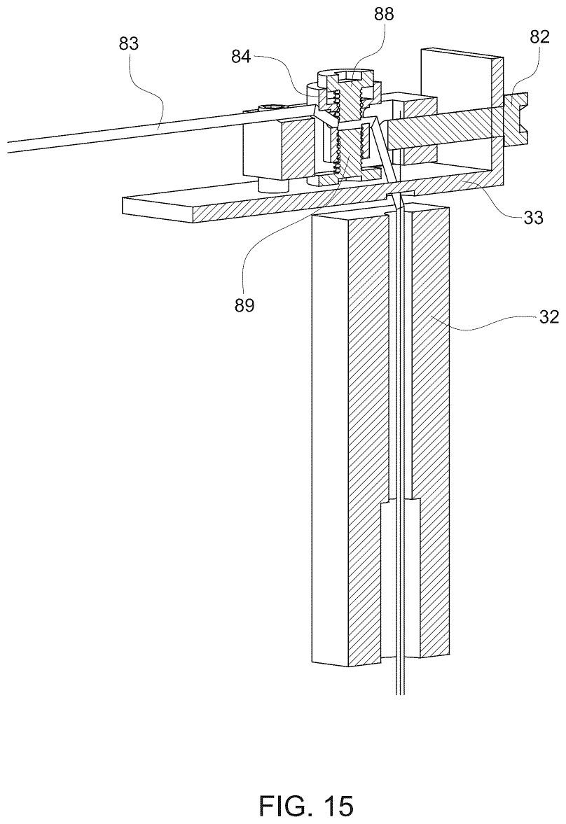

FIG. 15 is a sectional perspective view of the saddle block stabilising device of FIG. 14;

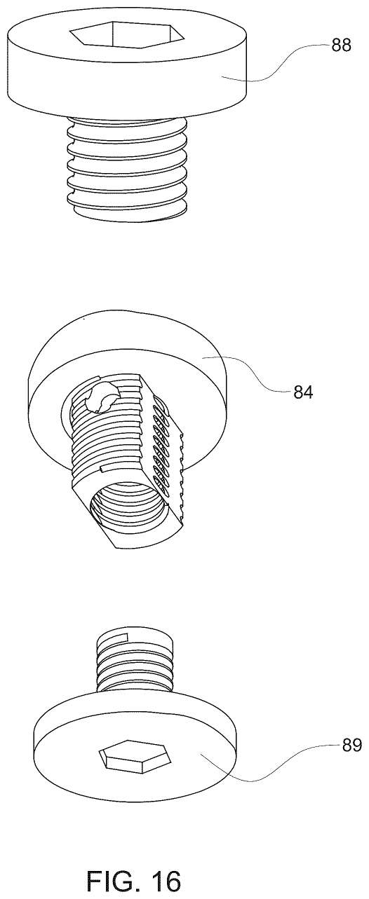

FIG. 16 is an exploded perspective view of a detail of the saddle block stabilising device of FIG. 14;

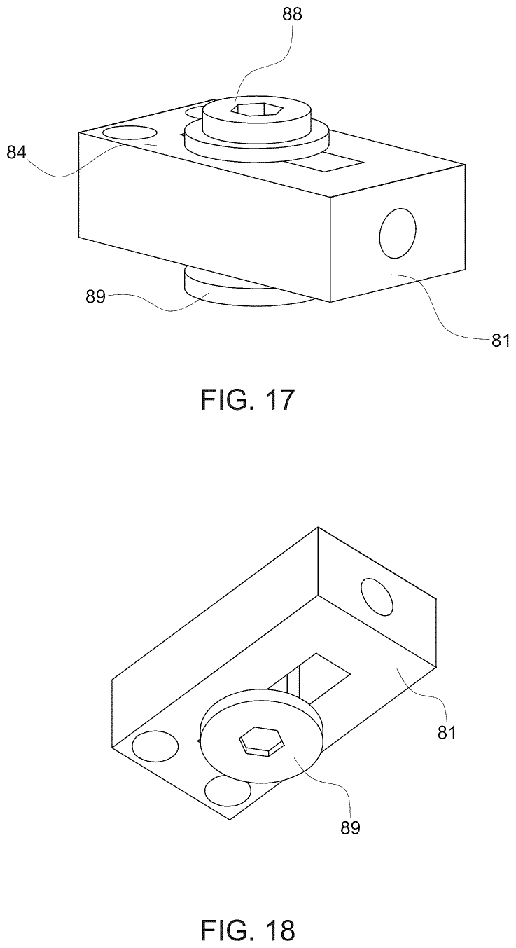

FIGS. 17 and 18 are perspective views of a detail of the saddle block stabilising device of FIG. 14;

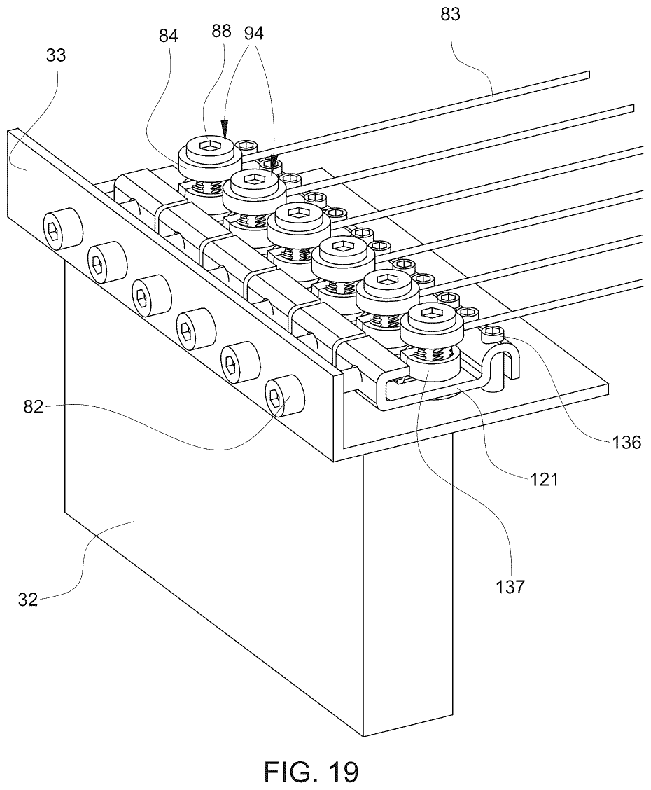

FIG. 19 is a perspective view of a saddle block stabilising device according to another embodiment of the invention;

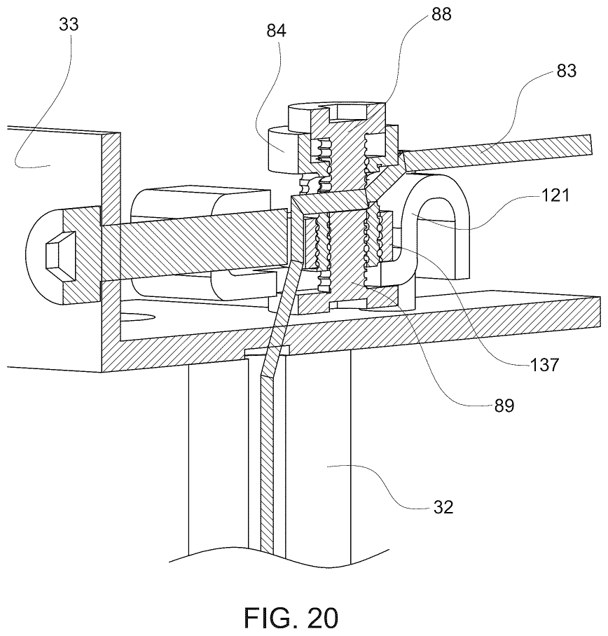

FIG. 20 is a sectional perspective view of the saddle block stabilising device of FIG. 19;

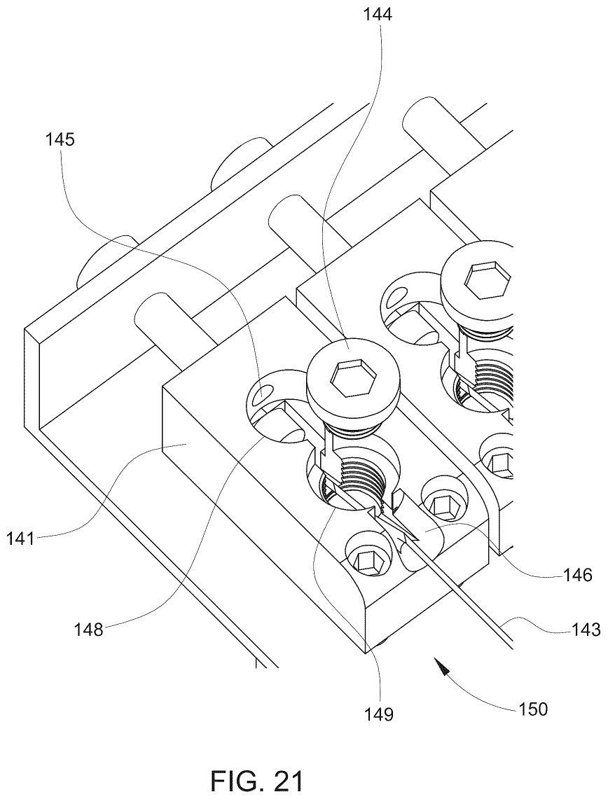

FIG. 21 is a perspective view of a saddle block stabilising device according to another embodiment of the invention;

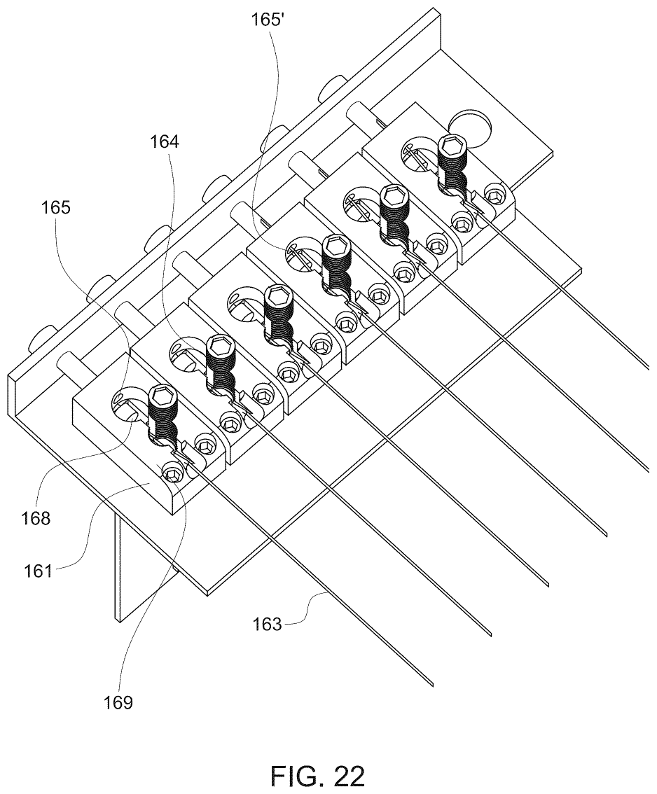

FIG. 22 is a perspective view of a saddle block stabilising device according to another embodiment of the invention;

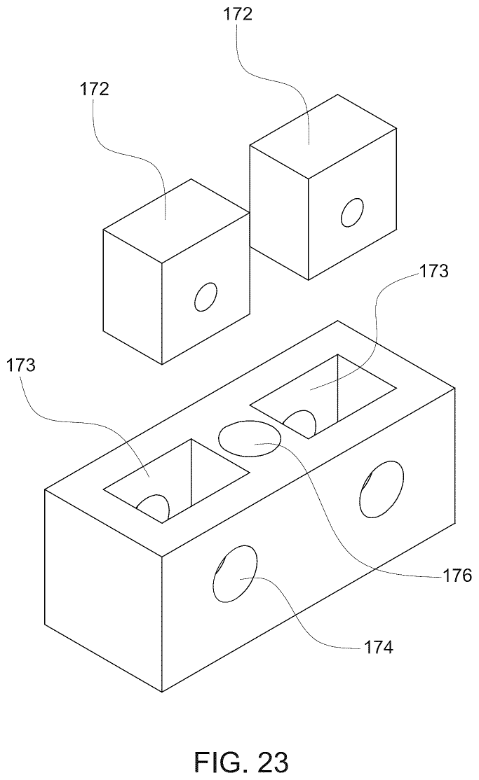

FIG. 23 is an exploded perspective view of a tool holder; and

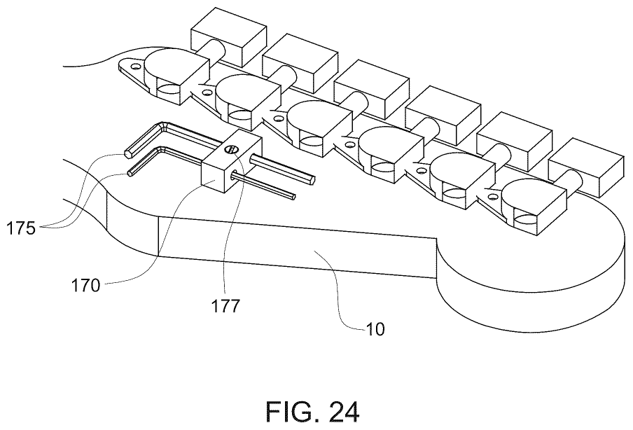

FIG. 24 is a perspective view of a tool holder of FIG. 23 attached to a guitar headstock.

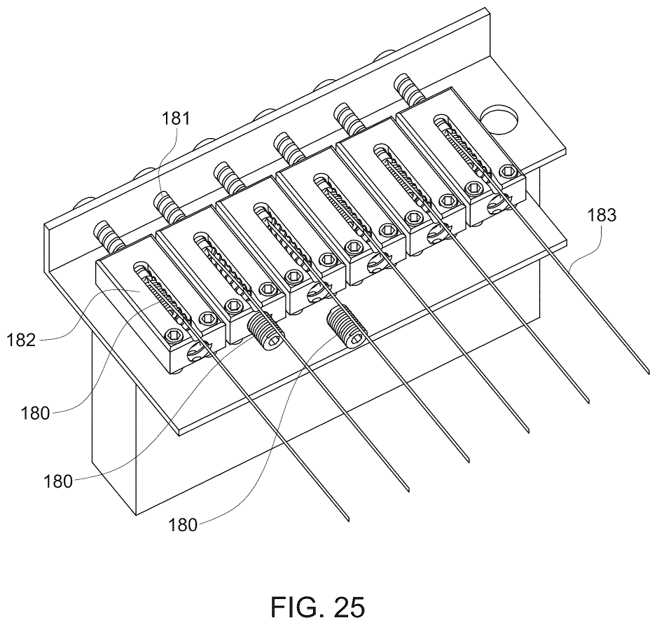

FIG. 25 is a perspective view of a saddle block stabilising device according to another embodiment of the invention;

Referring to FIG. 1, a guitar headstock 10 includes a number of conventional tuning machines or pegs 12, and stabilising devices 14, each of which comprise a top 15, body 16 and base screw 17. Ideally, each tuning peg has a corresponding stabilising devices 14, though less ideally only one or a subset of the tuning pegs could have stabilising devices associated with them.

Referring to FIG. 2, a conventional tuning peg 12 comprises a knob or button 20, a gear section 22, and a tuning post 24, which protrudes through the hole made in the guitar headstock to accommodate the tuning peg, the tuning head being fixed in place by a bushing 25 and nut 26.

The base screw 17 is tubular cylinder, having an inner bore that extends through the tube and is open at each end, and the inner bore is dimensioned such that the inner diameter allows the base screw to be slid over a standard tuning post 24. The base screw 17 is placed over the tuning post 24 with its bottom edge located above the nut 26.

A standard tuning post 24 is a rod having a cross bore 29 extending through the width of the rod, perpendicular to the longitudinal axis of the rod, each open end of the bore being diametrically opposite. The base screw 17 includes two diametrically opposed holes 28, each of which extend through the cylindrical wall of the base screw 17; these holes 28 are positioned on the base screw 17 to align with the cross bore 29 of the tuning post 24 when the base screw 17 is resting on the nut 26 of the tuning post 24. The diameter of the holes 28 is comparable to the diameter of the cross bore 29, and at least sufficient to accommodate the width of a guitar string. The base screw 17 screw also has a collar which extends circumferentially around the lower part of the base screw 17, below the holes.

The body 16 of the stabilising device 14 has a central bore having an inner diameter which allows the body 16 to fit over the outer diameter of the base screw 17. The outer surface of the base screw 17 and the inner surface of the body 16 have cooperating threads, so that the body 16 engages with the base screw 17 when placed upon it, allowing the body 16 to be screwed onto the base screw 17 so that they secure together, and the body 16 advanced onto the base screw 17. The outer circumference of the body 16 may feature knurling or a similar texture to allow a user to turn the body 16. The knurled surface may be born on a widened section of the body 16 as shown.

The top 15 of the stabilising device 14 is generally cylindrical, though having an upper cylinder section and a lower cylinder section which has a smaller diameter than the upper cylinder section, the two cylinder sections being concentric.

The outer diameter of the upper cylinder section of the top 15 is dimensioned to fit inside the bore of the body 16, and the outer surface of the upper cylinder section of the top 15 and the inner surface of the bore of the body 16 have cooperating threads, so that the top 15 may be screwed into the body 16 so that they secure together, and the top 15 advanced into the body 16. The top 15 has a slot and hexagonal hole on the upper face of the upper cylinder section, to allow the top 15 to be turned using either a slotted screwdriver or a hexagonal key such as an Allen key.

In order to secure the string to the tuning peg 12, the base screw 17 is placed on the tuning post 24 so that the holes of the base screw 17 and the cross bore 29 of the tuning post 24 are aligned, and the string is fed through the bridge holes 28 and cross bore 29. The body 16 is then screwed onto the base screw 17 to clamp the string by the user rotating the knurled surface, and the top 15 is screwed into the body 16 by the user using a screwdriver of hexagonal key. The body 16 and the base screw 17 are now secured together, so that turning the top into the body advances downwards through relative to the body and base screw 17. The lower cylinder section of the top 15 contacts and bears against the upper surface of the tuning post 24, urging the base screw 17 and body 16 upwards. This causes the holes 28 of the base screw 17 to rise relative to the cross bore 29 of the tuning post 24, gripping the string. The position of the string is now secure.

Guitar strings are often supplied with one end terminating with a ball or nut, by which means the guitar string, which allows the string to be constrained at the bridge (or tremolo block if used) of a conventional guitar. When the stabilising device 14 of the present invention are used, the string may be fed through in either direction, so that the ball is located at the headstock 10 or the saddle block/bridge/tremolo block (if a tremolo block is used) as desired; further, the ball may be removed, or a string without a ball used.

A conventional guitar includes strings which extend between the headstock and the body of the guitar. On the body, the guitar strings may terminate and be secured at their ends at the bridge, or the strings may extend past the bridge to a tremolo block held in the body of the guitar, which allows the tension and length of the strings to be varied to alter the pitch of the guitar strings during use.

Stabilising device according to the present invention may be provided for either instance; those for securing the strings to a tremolo block will be described first.

Referring to FIG. 4, the base screw 17 may be provided with one or more securement holes 27 located in a widened collar to provide enough material to tap threads into, ideally spaced from the holes 28, for example four holes 27 distributed at equal angles around the circumference of the base screw 17. The holes 27 include an internal thread. The grub screws 30 engage with the internal thread of the securement holes 27. The grub screws may then be advanced radially inwardly, so that they protrude into the inner bore of the base screw 17, and engage with the tuning post 24. Conventional tuning post 24 has a circumferentially extending concavity, intended to allow a string to be wrapped around the tuning post 24. The grub screws (which may have a hexagonal Allen key type aperture for to aide rotation) ideally engage with the tuning post 24 in the region of this concavity. If the string breaks or for some other reason becomes free from the stabilising device 14, the screws 30 retain the stabilising device 14 on the headstock 10 of the guitar so they are not lost.

Referring to FIG. 5, a conventional tremolo device for an electric guitar comprises a tremolo block 32 and tremolo bridge plate 33, the tremolo block 32 extending through the body of the guitar (not shown). The tremolo block 32 has a linear series of open-ended bores 37 extending through the block through which the guitar strings extend, conventionally being secured at the lower end of the tremolo block 32.

Tremolo stabilising devices 40, each of which comprise a block insert 34, a washer 36, and a vented screw 38, are provided, ideally, each one tremolo stabilising device being provided for each bore 37 of the tremolo block 32, though less ideally only one or a subset of the bores 37 could have stabilising devices associated with them. Additionally, a holding plate 35 is also provided.

The block insert 34 of the tremolo stabilising device 40 is cylindrical, and has diameter which allows the block insert 34 to be placed in a bore 37 of the tremolo block 32. The block insert 34 also has a collar at one end of the cylinder which has a wider diameter than the bores 37 of the tremolo block 32, so that the block insert 34 can only slide into the tremolo block 32 until the collar constrains its movement. The edge of the collar of block insert 34 can be shaped or crenulated, having two initial cut-out regions identical to 62 shown in FIG. 10, which extend from the edge of the collar upwards along the collar for a first length. The cut-out regions 62 are shaped so as to leave surfaces 63 on the collar, the two surfaces 63 of each collar being coplanar, and the two sets of surface of each collar being in parallel planes. When the block inserts 34 are all orientated such that the slots of the block inserts 34 are all directed to point perpendicularly to the plane of the tremolo block as shown, the holding plate 35 will fit over all the cut-away portions of the block inserts 34. Each of the block inserts 34 are thus constrained in this orientation and any rotation is prevented. The block insert 34 also has a longitudinal threaded bore open at both ends. The vented screw 38 of the tremolo stabilising device 40 has a cylindrical body having an outer diameter that corresponds to the inner diameter of the bore of the block insert 34, and is correspondingly threaded, so that the vented screw 38 engages with the block insert 34 when placed in the bore of the block insert 34, allowing the vented screw 38 to be screwed into the block insert 34 so that they secure together, and the vented screw 38 advances into the block insert 34. The vented screw 38 has a head, having a larger diameter than the cylindrical body. The head of the vented screw 38 has a slot and hexagonal hole on the upper face of the upper cylinder section, to allow the top of the screw 38 to be turned using either a slotted screwdriver or a hexagonal key such as an Allen key. The vented screw 38 also has a longitudinal bore open at both ends, of a sufficient diameter to allow a guitar string to pass through the bore.

The tremolo stabilising device 40 includes a washer 36 having an annular shape, dimensioned so that the cylindrical body of the vented screw 38 can pass through it, but also such that the washer 36 is gripped between the head of the vented screw 38 and the collar of the block insert 34. The holding plate 35 is rectangular in form, with a rectangular aperture, the aperture being wide enough to allow the cylindrical body of the vented screw 38 can pass through it, (like the washer 36) but narrow enough that the head of the vented screw 38 and the collar of the block insert grips it.

To use the tremolo stabilising device 40, the block inserts 34 are inserted into the tremolo block 32, the holding plate 35 is placed over the block insert 34 so that the bore of each block insert 34 is accessible through the holding plate 35, and a vented screw 38 is inserted through a washer 36 and the aperture of the holding plate 35 into the bore of the block insert 35, the external thread of the vented screw 38 engaging with the internal thread of the block insert 34. A guitar string is then fed through the bores of the tremolo block 32 and block insert 34, and through the bore of the vented screw 38. The guitar string may be fed through the tremolo block 32, block insert 34 and vented screw 38 either from the direction of the upper/forward surface of the tremolo block 32 (i.e. the part that is adjacent the front of the guitar), or from the vented screw 38 (i.e. from the back of the guitar). Guitar strings are often supplied with one end terminating with a ball, and if it is desired that the ball should be retained at the tremolo end, then obviously the free end of the guitar string must be fed through the vented screw 38 first.

When the guitar string has been fed through so that there is sufficient length to run between the bridge and the tuning peg on the headstock, the end of the guitar string that extends from the head of vented screw 38 may be secured in a number of ways. The protruding string may be wrapped from the vented screw 38 to extend between the holding plate 35 and the washer 36, and the vented screw 38 then screwed into the base screw 17 so that the washer 36 and holding plate 35 are forced together, gripping the string in position. The protruding string may, after being introduced between the washer 36 and the holding plate 35, then be threaded through the gap between the opening of the washer 36 and the cylindrical body of the vented screw 38, so that when vented screw 38 then screwed into the base screw 17, the string is gripped both between the washer 36 and holding plate 35, and between the head of the vented screw 38 and the upper surface of the washer 36. Alternatively, it is also possible to wrap the string by giving it a knot around the thread of the vented screw 38.

Referring to FIG. 7, in another embodiment, the tremolo stabilising device 50 may comprise a block insert 44 and screw 49 which have corresponding engaging screw threads, the tremolo stabilising device 50 again placed in the bores (or a subset thereof) of a tremolo block 32 as previously, and a holding plate 45 extended along all the tremolo stabilising devices 50. As for the embodiment described and shown in FIGS. 5 and 6, the block insert 44 of the tremolo stabilising device 50 is cylindrical, and has diameter which allows the block insert 44 to be placed in a bore 37 of the tremolo block 32. The block insert 44 also has a collar at one end of the cylinder which has a wider diameter than the bores 37 of the tremolo block 32, so that the block insert 44 can only slide into the tremolo block 32 until the collar constrains its movement. The block insert 44 also has a longitudinal bore open at both ends, however this bore is not threaded, and need only have an internal diameter sufficient to allow a guitar string to be passed through the bore. The collar of the block insert 44 includes a cross bore which extends from the longitudinal bore to the outer diameter, and this cross bore is threaded.

A screw 49 of the tremolo stabilising device 50 has a cylindrical body having an outer diameter that corresponds to the inner diameter of the cross bore of the block insert 44, and is correspondingly threaded, so that the screw 49 engages with the cross bore of the block insert 44 when placed in the cross bore of the block insert 44, allowing the screw 49 to be screwed into the block insert 44 so that they secure together, and the screw 49 advanced into the block insert 44 towards the longitudinal bore of the block insert 44. The screw 49 has a head, having a larger diameter than the cylindrical body. The head of the screw 49 has a slot and hexagonal hole on the upper face of the upper cylinder section, to allow the screw 49 to be turned using either a slotted screwdriver or a hexagonal key such as an Allen key. The screw 49 in this embodiment does not (or need not) have a longitudinal bore.

The holding plate 45, as for the embodiment described and shown in FIGS. 5 and 6, is rectangular in form, with a rectangular aperture, the aperture being wide enough to allow the cylindrical body of the screw 49 can pass through it, but narrow enough that the head of the screw 49 and the side of the block insert grips it.

To use the tremolo stabilising device 50, the block inserts 44 are inserted into the tremolo block 32, and each aligned such that the openings of the cross bore are all directed to point perpendicularly to the plane of the tremolo block 32 as shown. The holding plate 45 is positioned so that the openings of the cross bores of the block insert 44 are accessible through the aperture of the holding plate 45, and each screw 49 is inserted through the aperture of the holding plate 45 into the cross bore of a block insert 44. A guitar string is then fed through the bores of the tremolo block 32 and block insert 44.

When the guitar string has been fed through so that there is sufficient length to run between the bridge and the tuning peg on the headstock, the end of the guitar string that extends from the end of the block insert 44 may be secured by tightening the screw 49, so that the string is gripped in the longitudinal bore of the block insert 44.

It will be noted that a washer is ideally not used in this embodiment.

As for the embodiment described and shown in FIGS. 5 and 6, the guitar string may be fed through the tremolo block 32, block insert 44 and screw 38 from either direction.

Referring to FIG. 8, in another embodiment, the tremolo stabilising device 60 may comprise a block insert 54, and string locking grub screw 58, the tremolo stabilising device 60 again placed in the bores (or a subset thereof) of a tremolo block 32 as previously. As for the embodiment described and shown in FIGS. 5 and 6, the block insert 54 of the tremolo stabilising device 60 is cylindrical, and has diameter which allows the block insert 54 to be placed in a bore 37 of the tremolo block 32. The block insert 54 also has a collar at one end of the cylinder which has a wider diameter than the bores 37 of the tremolo block 32, so that the block insert 54 can only slide into the tremolo block 32 until the collar constrains its movement. The block insert 54 also has a longitudinal bore open at both ends, this bore having an internal thread for the length of the collar. The collar also includes a slot, which extends longitudinally from the distal end of collar.

The grub screw 58 of the tremolo stabilising device 60 has a cylindrical body having an outer diameter that corresponds to the inner diameter of the bore of the block insert 54 at the collar, and is correspondingly threaded, so that the grub screw 58 engages with the bore of the block insert 54 when placed in the bore of the block insert 54, allowing the grub screw 58 to be screwed into the block insert 54 so that they secure together, and the grub screw 58 advances into the block insert 54 towards the longitudinal bore of the block insert 54, so as to extend to the upper end of the collar slot of the block insert 54. The grub screw 58 has a head, having a larger diameter than the cylindrical body. The head of the screw 58 has a hexagonal hole on the upper face of the upper cylinder section, to allow the grub screw 58 to be turned using a hexagonal key such as an Allen key. The grub screw 58 in this embodiment does not have a longitudinal bore.

To use the tremolo stabilising device 60, the block inserts 54 are inserted into the tremolo block 32, and each aligned such that the collar slots of the block inserts 54 are all directed to point perpendicularly to the plane of the tremolo block 32 as shown. A guitar string is then fed through the bores of the tremolo block 32 and block insert 54, and the end of the guitar string is positioned so that it extends through the collar slot of the block insert 54. The grub screw 58 is then inserted into the bore of the block insert 54 and rotated so that the threads of the grub screw 58 and block insert 54 engage and drive the grub screw 58 into the block insert 54. The upper face of the grub screw 58 (i.e. the face of the grub screw 58 introduced into the bore of block insert 54) advances along the collar slot of the block insert 54, until the guitar string is gripped between the block insert and the grub screw 58.

A holding plate need not be used in this embodiment. However, referring to FIG. 9, a holding plate 55 could be included; in this embodiment, the width of the holding plate 55 aperture is just sufficient for the holding plate 55 to clear the collar of the block insert 54 when the block inserts 54 are oriented such that the slots of the block inserts 64 (shown in FIG. 10) are all directed to point perpendicularly to the plane of the tremolo block as shown, the diameter of the collar having been somewhat reduced due to the location of the slots. The holding plate 55 thus constrains any rotational movement of the block insert 54 once the holding plate 55 is located in this way. The guitar string may be threaded either between the holding plate 55 and the end of the slot of the block insert 54, or between the holding plate 55 and the head of the screw 58 (though still ideally located in the slot of the of the block insert 54), in both cases the rotation and advancement of the screw 58 causing the guitar string to be clamped.

Referring to FIGS. 10 and 11, in another embodiment, the tremolo stabilising device 70 may comprise a block insert 64, and string locking screw 68, and additionally a common holding plate 65. As for the other the tremolo stabilising devices described the tremolo stabilising device 60 is again placed in the bores (or a subset thereof) of a tremolo block 32 as previously. As for the embodiment described and shown in FIG. 7, the block insert 64 of the tremolo stabilising device 60 is cylindrical, and has diameter which allows the block insert 64 to be placed in a bore of the tremolo block. The block insert 64 also has a collar at one end of the cylinder which has a wider diameter than the bores of the tremolo block, so that the block insert 64 can only slide into the tremolo block until the collar constrains its movement. The block insert 64 also has a longitudinal bore open at both ends, and the bore has an internal thread for the length of the collar. The edge of the collar is shaped or crenulated, having two initial cut-out regions 62, which extend from the edge of the collar upwards along the collar for a first length, and then a slot 61, which extends upwards along the collar for a second greater length, ideally the slot 61 coinciding with the cut-out region 62 as shown. The cut-out regions 62 are shaped so as to leave surfaces 63 on the collar, the two surfaces 63 of each collar being coplanar, and the two sets of surface of each collar being in parallel planes.

As for the embodiment described and shown in FIG. 5, a holding plate 65 is also provided, and this is incorporated in a similar way to that embodiment. Additionally, through, the width of the aperture of the holding plate 65 and the distance between the two sets of surfaces 63 of each collar of a block insert 64 are sized to correspond, so that when the block inserts 64 are all orientated such that the slots of the block inserts 64 are all directed to point perpendicularly to the plane of the tremolo block as shown, the holding plate 65 will fit over all the cut-away portions of the block inserts 64. Each of the block inserts 64 are thus constrained in this orientation and any rotation is prevented.

As for the embodiment shown and described in FIG. 8, the screw 68 of the tremolo stabilising device 70 has a cylindrical body having an outer diameter that corresponds to the inner diameter of the bore of the block insert 64 at the collar, and is correspondingly threaded, so that the screw 68 engages with the bore of the block insert 64 when placed in the bore of the block insert 64, allowing the screw 68 to be screwed into the block insert 64 so that the screw 68, holding plate 65 and block insert 64 are secured together, and the screw 68 advanced into the block insert 64 towards the longitudinal bore of the block insert 64, so as to extend to the upper end of the collar slot of the block insert 64. The screw 68 has a head, having a larger diameter than the cylindrical body. The head of the screw 68 has a hexagonal hole on the upper face of the upper cylinder section, to allow the top 68 to be turned using a hexagonal key such as an Allen key. The screw 68 in this embodiment could also have a longitudinal bore.

To use the tremolo stabilising device 60, the block inserts 64 are inserted into the tremolo block, and each aligned such that the collar slots of the block inserts 64 are all directed to point perpendicularly to the plane of the tremolo block as shown. A guitar string is then fed through the bores of the tremolo block and block insert 64, and the end of the guitar string is positioned so that it extends through the collar slot of the block insert 64. The holding plate 65 is then placed over the set of block inserts 64 and grub screws 68 are then inserted sequentially into the bore of each block insert 64 and rotated so that the threads of the screw 68 and block insert 64 engage and drive the screw 68 into the block insert 64, also securing the holding plate 65. The guitar string can either be constrained between the holding plate 65 and the block insert 64 in the slot of the block insert 64, or could be threaded between the head of the screw 68 and holding plate 35 and held between these components, or could be first threaded through the slot of the block insert 64 and held between the holding plate 65 before being wrapped around the shaft of the screw 68 and further held by the screw 68 and holding plate 65.

Referring to FIGS. 12 and 13, in another embodiment, the tremolo stabilising device 80 may comprise a block insert 74, and string locking grub screw 78, and additionally a common holding plate 75. As for the other the tremolo stabilising devices described the tremolo stabilising device 80 again placed in the bores (or a subset thereof) of a tremolo block 32 as previously. The block insert 74 of the tremolo stabilising device 80 is similar to that described and shown in FIGS. 10 and 11, being cylindrical, and having diameter which allows the block insert 74 to be placed in a bore of the tremolo block. The block insert 74 also has a collar at one end of the cylinder which has a wider diameter than the bores of the tremolo block, so that the block insert 74 can only slide into the tremolo block until the collar constrains its movement. The block insert 74 also has a longitudinal bore open at both ends, and the bore has an internal thread for the length of the collar. The edge of the collar is shaped, having a slot 71 similar to that of the slot of the block insert 54 of the embodiment shown and described in FIG. 8, extending from the distal edge of the block insert 74. Additionally, the collar of the block insert 74 includes opposing cut-out apertures 72 which extend through the wall of the collar, but which do not extend from the edge of the distal edge of the collar.

As for the embodiments described and shown in FIG. 5 and FIGS. 10 and 11, a holding plate 75 is also provided which runs along the set of tremolo stabilising devices 74. The cut-out apertures 72 and holding plate 75 here however are dimensioned such that when the block inserts 74 are all orientated such that the slots of the block inserts 74 are all directed to point perpendicularly to the plane of the tremolo block as shown, the holding plate 75 can be slid through all the cut-out apertures 72 of the block inserts 74. Each of the block inserts 74 are thus constrained in this orientation and any rotation is prevented.

As for the embodiment shown and described in FIGS. 10 and 11, the grub screw 78 of the tremolo stabilising device 70 has a cylindrical body having an outer diameter that corresponds to the inner diameter of the bore of the block insert 74 at the collar, and is correspondingly threaded, so that the grub screw 78 engages with the bore of the block insert 74 when placed in the bore of the block insert 74, allowing the grub screw 78 to be screwed into the block insert 74 so that the grub screw 78, holding plate 75 and block insert 74 are secured together, and the grub screw 78 advanced into the block insert 74 towards the longitudinal bore of the block insert 74, so as to extend to the upper end of the collar slot of the block insert 74. The grub screw 78 has a head, having a larger diameter than the cylindrical body. The head of the screw 78 has a hexagonal hole on the upper face of the upper cylinder section, to allow the top 78 to be turned using a hexagonal key such as an Allen key. The grub screw 78 in this embodiment could also have a longitudinal bore.

To use the tremolo stabilising device 80, the block inserts 74 are inserted into the tremolo block, and each aligned such that the collar slots of the block inserts 74 are all directed to point perpendicularly to the plane of the tremolo block as shown. The holding plate 75 is slid through the cut-out apertures 72. A guitar string is then fed through the bores of the tremolo block and block insert 74, and the end of the guitar string is positioned so that it extends through the collar slot of the block insert 74, across the surface of the holding plate 75 as shown. The grub screws 78 are then inserted sequentially into the bore of each block insert 74 and rotated so that the threads of the grub screw 78 and block insert 74 engage and drive the grub screw 78 into the block insert 74, also securing the string between the holding plate 75 and the head of the grub screw 78.

As previously noted, stabilising devices according to the present invention may also be provided for the bridge rather than on the lower end of the tremolo block (i.e. at the back of the guitar where the strings terminate), or when a tremolo block is not provided, used or required.

Referring to FIGS. 14 and 15, one conventional type of a tremolo block 32 and tremolo bridge plate 33 includes saddle blocks 81 each of which includes a longitudinal bore which is engaged by an intonation screw which also passes through the flange of the bridge plate 33, and which allows the length and tension of each string 83 to be adjusted to make alterations to the pitch of the string. The string 83 extends from the headstock along the neck and body of the guitar to the saddle blocks 81, where it is directed through the saddle blocks 81 to the tremolo block 32.

In this design of saddle block 81, each saddle block 81 has a channel open on the upper and lower side of the saddle blocks 81 to allow the through passage of a string 83.

Saddle stabilising devices 94 are fitted in the saddle blocks 81, ideally each saddle block 81 is equipped with a saddle stabilising device 94 though less ideally only one or a subset of the tuning pegs could have stabilising devices associated with them.

Each saddle stabilising device 94 comprises an upper screw 88, a block insert 84 and a base screw 89. The upper screw 88 and the base screw 89 are similar, each having a threaded shaft and a radially wider head, which features a hexagonal hole which may engage a hexagonal key such as an Allen key in order to be rotated.

The block insert 84 of the stabilising device 94 has a generally cylindrical body (though featuring flats as will be described below) with a cylindrical central bore having an inner diameter which allows the shafts of the upper screw 88 and base screw 89 to be inserted from opposite ends. The central bore is threaded so that the upper screw 88 and base screw 89 both engage with the central bore and advance into the block insert 84 when respectively rotated. The length of the shafts of the upper screw 88 and base screw 89 are such that the ends of the respective shafts can abut or nearly abut when the screws are sufficiently advanced.

Referring also to FIG. 16, the block insert 84 has a widened upper collar, so that the block insert 84 is constrained against the top surface of the saddle blocks 81. The upper surface of the widened upper collar of the block insert 84 has a central countersunk cavity which accommodates the head of the upper screw 88. Referring also to FIG. 17, the flats of the outer surface of the cylindrical body of the block insert 84 (which are described and shown for later embodiments below) allow the block insert 84 to be placed in the rectangular channel of the saddle block 81, and allow movement along the channel, but prevent rotation of the block insert 84. The block insert 84 includes a cross bore which extends through the walls of the cylindrical body of the block insert 84, to provide two opposing opening holes which communicate with the central bore of the block insert 84.

In order to secure the string to the saddle block 81, the string 83 is fed through the cross bore of the block insert 84, and the block insert 84 is placed in the saddle block 81. The upper screw 88 and base screw 89 are inserted into the central bore of the block insert 84 and both screws are tightened or rotated so they advance towards each other. The opposing ends of the upper screw 88 and base screw 89 come together in the region of the cross bore of the block insert 84, and grip the string 83 securely. The saddle block 81 can be secured to the tremolo bridge plate 33 in the conventional manner, and the position (and thus the tension and length, and thus the pitch) of the string is set.

Referring to FIGS. 19 and 20, another conventional type of a tremolo block 32 and tremolo bridge plate 33 includes saddle blocks 121 which comprise a shaped metal sheet, having a hump at one end which locates each saddle blocks 121 on the tremolo bridge plate 33 with two grub screws 136, while at the other end of the saddle blocks 121 a flange allows engagement with a intonation screw 82 to secure the saddle block 121 at the other end and to allow adjustment of the position of the saddle block 121 for fine tuning.

This saddle block 121, as for the saddle blocks 81 shown in FIGS. 14 and 15, also has a rectangular channel open on the upper and lower side of the saddle blocks 121 to allow the through passage of a string 83, however since this saddle block is formed of sheet metal, the height of the rectangular channel is less.

The saddle stabilising device 94 comprises an upper screw 88, a block insert 84 and a base screw 89, which are formed in the same way as for the saddle stabilising device described and illustrated in FIGS. 14 and 15. Additionally, an annular spacer ring 137 is provided, whose inner threaded diameter is sufficient to allow the cylindrical block insert 84 to engageably pass through, but whose outer diameter prevents the passage of the head of the block insert 84, and also prevents the spacer ring 137 from passing through the rectangular channel of the saddle block 121.

In order to secure the string to the saddle block 121, the string 83 is threaded through the cross bore of the block insert 84, and the block insert 84 is placed in the saddle block 121. The spacer ring 137 is fitted over the generally cylindrical body of the block insert 84, and the upper screw 88 and base screw 89 are inserted into the central bore of the block insert 84 and both screws are tightened or rotated so they advance towards each other to grip the string 83 as described and illustrated in FIGS. 14 to 15, with the spacer ring 137 making up the difference in height between the saddle blocks 121 of this embodiment and the saddle block shown and described in FIGS. 14 and 15; the saddle block 121 is then secured to the tremolo bridge plate 33 in the conventional manner.

The previous embodiments of saddle stabilising devices all operate with known conventional saddle blocks. Referring to FIG. 21, the saddle block 141 is of a modified form, and has an open bore 148 which extends between the upper and lower surfaces of the saddle block 141, and a cavity 149 which is open on the upper surface of the saddle block 141, but which need not be open on the lower surface. The bore 148 and cavity 149 are ideally longitudinally aligned, with the cavity 149 located closer to the headstock than the bore 148. The cavity 149 is cylindrical and has an internal bore, and opposing slots running from the upper surface of the saddle block 141 downwards which allows the cavity 149 to communicate with the saddle 146 and the bore 148 respectively. A block insert 144 has a cylindrical threaded shaft that corresponds to the cavity 149, and a head featuring a hexagonal hole to be driven with a hexagonal Allen key, the cavity 149 being countersunk to accommodate the head of the block insert 144. The bore 148 features an axial channel which communicates with the outer surface of the saddle block 141, whose use will be explained with reference to the similar axial channel shown in FIG. 22.

In order to secure a guitar string 143, the string is fed through the saddle 146, and the slots of the cavity 149, and through the bore 148 to the back of the guitar. The block insert 144 is then screwed into the cavity 149 so that the respective threads of the block insert 144 and the cavity 149 engage and the block insert 144 advances downwards in the cavity 149. The block insert 144 constraints and grips the string 143 at the bottom of the slots of the cavity 149, preventing movement of the string at that point, and thus also constraining the position of the string on the saddle 146 of the saddle block 141, which fixes the length and tension, and therefore the pitch, of the string. It will be observed that the modified saddle blocks 141, by providing constraining surfaces and engaging thread which interact with the block insert 144, allows the upper screw and base screw described and illustrated in previous saddle stabilising devices herein described to be dispensed with.

Referring to FIG. 22, the block insert described and illustrated in FIG. 21 may be adapted to be of a grub screw type, that is, having a threaded cylindrical body without a separate unthreaded widened head, but still having a hexagonal hole in the upper surface that allows the block insert 164 to be rotated and thus advanced into the saddle block 161. The cavity 169 in the saddle 161 for receiving the block insert 164 may be purely cylindrical without a countersunk section, unless it is desired that the saddle block 161 should accept both the block insert 164 shown here and the block insert 144 shown in FIG. 21. The saddle 161 allows the string installation either from 165′, the tremolo block 32 or from the Headstock as described herein.

The guitar string is secured in the same manner as described for FIG. 21. Like the saddle block shown in FIG. 21, the bore 168 features an axial channel 165 which communicates with the outer surface of the saddle block 161; as alternative to passing the string through the bore 168 to the back of the guitar, the string 163 may be extended through the axial channel 165′, as shown for the three rightmost saddle blocks. The saddle block shown in 21 may similarly be configured in this way.

Referring to FIG. 25, the saddle block shown in FIG. 22 may also be modified by providing a saddle insert 180 having a threaded cylindrical body, and having a hexagonal hole in the upper surface that allows the block insert 180 to be rotated and thus advanced into the saddle 182 in the same axis and towards the intonation screw to lock and secure the string against the end of the intonation screw 181. The saddle 182 allows the string installation either from the saddle 182 (vented screw type), the tremolo block 32 or from the Headstock as described herein.

For all embodiments described and illustrated, upper screws, block inserts and base screws described herein that are rotated by a hexagonal key or a screwdriver may be provided with a head, or may be of the headless grub screw type unless the head is specifically used to secure a string or other component, with corresponding provision or removal of a countersunk region of the threaded bore they are to be receiving in as necessary. Such screws may feature a hexagonal hole for an Allen type key, or appropriate slots to accept a flat-headed or cross-headed screwdriver, or a combined feature to accept more than one type of rotational driving tool, or some other engagement feature. Equally, they may be provided with a head having a knurled edge to allow manual rotation in a similar way to body 16 of the headstock stabilising device and other similar knurled edge components described herein.

Some screws have been described as having a knurled edge to allow manual rotation; equally, other surfaces and/or textures, or shapes such as lugs of wings, may be provided to allow manual operation, or a shaped outer surface (for example a hexagonal) could be provided to allow a tool (such as a spanner) to be used to engage the screw and rotate it. Alternative rotation means such as an engaging hole and gear teeth could be provided on parts that are to be rotated relative to each other, so that they may be rotated using a toothed key, in the manner similar to that of a conventional drill chuck. Alternatively, a transverse bore could be provided which allows a tool to being inserted in the bore to rotate the part in the manner of a box or tube spanner.

The block insert 34 shown in FIG. 5, and the other similar block inserts for other tremolo block configurations, are shown as cylindrical, since the channels provided in conventional tremolo blocks are typically cylindrical. It will be appreciated though that other sections or shapes could be provided, particularly if a tremolo block features channels having a non-cylindrical shape.

Tools such Allen keys for use with the stabilising systems described herein and for other uses, may conveniently be stored in a tool holder secured to the guitar. Referring to FIG. 23, a tool holder comprises a holder block 170 having two generally cuboid rubber inserts 172. The holder block 170 has corresponding rectilinear cavities 173 which accept the rubber inserts 172. Each rubber insert 172 has a through bore 171, and the holder block 170 has apertures 174 in its walls positioned such that when the rubber inserts 172 are placed in the holder block 170, two through passages are defined by the apertures 174 and through bores 171. The holder bock 170 also includes a countersunk threaded bore 176 by which means the holder block may be secured to the guitar using a headed screw 177, FIG. 24 showing the holder block secured the headstock 10 of the guitar though of course the holder block could be positioned on the neck or body of the guitar. When so secured, the rubber inserts 172 are constrained in position in the holder block 170 by the headstock 10 itself.

The two through passages defined by the apertures 174 and through bores 171 allow tools such as hexagonal Allen type keys to be hold in the holder block 170 as shown in FIG. 24, the inner diameter and elasticity of the rubber inserts being such that the appropriate Allen key 175 can be held in one of the through passages of the holder block 170 until required by the user whereupon the Allen key 175 can be removed from the holder block 170.

The headstock stabilising devices, tremolo block stabilising devices and saddle block stabilising devices may be employed on a guitar independently of each other; however, the full advantage of the system is realised when the headstock stabilising devices as described herein is used on a guitar which also has a tremolo block stabilising devices or a saddle block stabilising devices as described herein.

Guitar strings may be attached by being thread through the or both stabilising devices in either direction, that is, either starting at the headstock and finishing at the body end of the guitar, or the other way around. Claims that recite an order in which the guitar string is fed through the components are not intended to imply a particular order in which the guitar string is fed through the components, which in general can be reversed.

In this specification an apparatus/method/product “comprising” certain features is intended to be interpreted as meaning that it includes those features, but that it does not exclude the presence of other features.

The following points of interest of the system and subsystems previously described are particularly noted
A1. A headstock stabilising device for a guitar string comprising;
a base screw, the base screw being generally cylindrical with an axial open bore capable of fitting over a guitar tuning post, and having a cylindrical wall having two generally opposing holes in the cylindrical wall, and having a threaded outer surface;
a body having an open bore which allows the body to fit over the outer diameter of the base screw, the open bore having a threaded inner surface which cooperates with the threaded outer surface of the base screw; a top comprising an upper cylinder section having a thread on the outer surface and
a drive shape on its upper surface, and a lower cylinder section which has a smaller diameter than the upper cylinder section, the upper cylinder section and a lower cylinder sections being concentric, the outer diameter of the upper cylinder section capable of fitting inside the open bore of the body, the thread of the upper cylinder section cooperating with the threaded inner surface of an outer bore of the body;
such that the base screw may be placed over a tuning post of a guitar headstock, a guitar string inserted through the opposing holes in the base screw and a radial bore of the tuning post, the body may be screwed onto the base screw, and the top may be screwed into the body, the top being advanced until the lower cylinder section grips the guitar string against the top of the tuning post and constrains the movement of the guitar string.
   A2. A headstock stabilising device according to point A1 wherein the outer circumference of the body textured or shaped to allow a user to turn the body.
   A3. A headstock stabilising device according to either previous point wherein the base screw has a collar.
   A4. A headstock stabilising device according to point A3 wherein the collar includes holes and screws to grip base screw against tuning post.
   A5. A headstock stabilising device according to point A4 wherein the screws are grub screws.
   A6. A headstock stabilising device according to any previous point wherein drive shape of top includes a hexagonal cavity.
   A7. A headstock stabilising device according to any of points A1 to A6 wherein the drive shape of top drive shape includes a linear slot.
   A8. A tremolo block stabilising device for a guitar string comprising;
   a block insert, a longitudinal threaded open bore, and a collar at one end of the block insert which has a larger diameter than the generally cylindrical body;
   a vented screw having a cylindrical body with a threaded outer diameter that cooperates with the longitudinal threaded open bore of the block insert, the cylindrical body having an open longitudinal bore, and the vented screw having a head which is wider than the cylindrical body;
   an annular washer, which allows the body of the vented screw to pass through but not wide enough to allow the head of the vented screw to pass through;
such that the block insert may be inserted into a bore in the tremolo block, the vented screw screwed into the block insert with the washer located between the block insert and the vented screw, a guitar string is then fed through the bore of the tremolo block, the bore of the block insert, and the bore of the vented screw, and the guitar string secured between the head of the vented screw and the block insert by further screwing the vented screw into the block insert.
   A9. A tremolo block stabilising device according to point A8 wherein the head of the vented screw has a drive shape on its surface.
   A10. A plurality of tremolo block stabilising devices according to point A8 or A9 additionally comprising a holding plate having a rectangular aperture wide enough to allow the cylindrical bodies of the vented screws can pass through it but not allow the heads of the vented screws to pass through it.
   A11. A plurality of tremolo block stabilising devices according to point A10 wherein the block inserts having a shaped collar which engages with the holding plate to prevent rotation of the block inserts.
   A12. A tremolo block stabilising device for a guitar string comprising
   a block insert, the block insert having a generally cylindrical body, a longitudinal open bore, at least one threaded radial bore that extends between longitudinal open bore and the outer surface of the cylindrical body, and a collar at one end of the block insert which has a larger diameter than the generally cylindrical body;
   a screw having a cylindrical body with a threaded outer diameter that cooperates with the threaded radial bore of the block insert;
such that the block insert may be inserted into a longitudinal threaded bore in the tremolo block, a guitar string is then fed through the bore of the tremolo block, the bore of the block insert, and the screw screwed into the threaded radial bore of the block insert, the guitar string secured between a head of the screw and the inner surface of the longitudinal threaded bore of the block insert.
   A13. A tremolo block stabilising device according to point AA12 wherein the head of the screw has a drive shape on its surface.
   A14. A plurality of tremolo block stabilising devices according to either point A12 or A13 wherein there is additionally provided a holding plate a holding plate having a rectangular aperture wide enough to allow the cylindrical bodies of the vented screws can pass through it but not allow the heads of the vented screws to pass through it.
   A15. A tremolo block stabilising device for a guitar string comprising
   a block insert, the block insert having a generally cylindrical body, a longitudinal threaded open bore, and a collar at one end of the block insert which has a larger diameter than the generally cylindrical body, the collar including a longitudinal slot;
   a vented screw having a cylindrical body with a threaded outer diameter that cooperates with the longitudinal threaded open bore of the block insert;
such that the block insert then inserted into a bore in the tremolo block, a guitar string then fed through the longitudinal slot, the bore of the tremolo block and the bore of the block insert, and through the screw screwed into the block insert to secure the guitar string between the screw and the block insert.
   A16. A tremolo block stabilising device according to point A15 wherein a head of the vented screw has a drive shape on its surface.
   A17. A plurality of tremolo block stabilising devices according to either point A15 or A16 wherein the block inserts have a cut out regions which engages with the holding plate to prevent rotation of the block inserts and additionally have a holding plate which engages with the cut out regions of the block inserts to prevent rotation of the block.
   A18. A saddle block stabilising device for a guitar string comprising
   a block insert, the block insert having a generally cylindrical body, a longitudinal threaded open bore, and a collar at one end of the block insert which has a larger diameter than the generally cylindrical body;
   an upper screw having a cylindrical body with a threaded outer diameter that cooperates with the longitudinal threaded open bore of the block insert, and the upper screw having a head which is wider than the cylindrical body;
   a lower screw having a cylindrical body with a threaded outer diameter that cooperates with the longitudinal threaded open bore of the block insert, and the lower screw having a head which is wider than the cylindrical body;
such that the block insert may be inserted into a bore in the saddle block, the upper screw screwed into the block insert, the lower screw screwed into the block insert, and a guitar string fed through the bore of the saddle block and the bore of the block insert the guitar string secured between the end of the upper screw and the end of the lower screw by further screwing the upper and/or lower screw into the block insert.
   A19. A saddle block stabilising device for a guitar string comprising
   a saddle block having a first open bore and a second threaded bore, a first passage between the first open bore and a second threaded bore and a second passage from the second threaded bore and the exterior of the saddle block;
   a screw having a cylindrical body with a threaded outer surface that cooperates with the second threaded bore of the saddle block;
such that a guitar string may be fed through the first passage of the saddle block, across the second threaded bore, through the second passage of the saddle block into the first open bore of the saddle block, and the screw inserted into the second threaded bore of the saddle block to secure the guitar string between the end of the screw and the surfaces of the first and/or second passage of the saddle block.
   A20. A guitar having a tool holder, the tool holder being secured to the guitar, the tool holder comprising a block with one or more through bores, the bores being resiliently deformable such that a tool can be inserted into the one or more holes to be securely gripped.
   A21. A guitar according to point A20 wherein the tool holder comprises a rigid housing and a resiliently deformable material inserted in the housing.
   A22. A guitar comprising
   a headstock stabilising device according to any of points A1 to A7
   and either a tremolo block stabilising device or devices according to any of points A8 to A17 or a saddle block stabilising device according to either of points A18 or A19.

Many variations are possible without departing from the scope of the present invention as defined in the appended claims.

1. A saddle block stabilising device for a guitar string comprising
a saddle block having
a first open bore suitable for providing a passage from the front of the guitar to the back of a guitar, and
an intonation screw
a locking screw having a cylindrical body with a threaded outer surface that cooperates with the second threaded bore;
optionally, a threaded insert, and
a second threaded bore, located either in the saddle block, or the threaded insert if present
such that a guitar string may be fed across the second threaded bore or the threaded insert, and the locking screw inserted into the second threaded bore of the saddle block or on the threaded insert to secure the guitar string between a surface of the locking screw and a surface of the saddle block, the intonation screw or the threaded insert.

2. A saddle block stabilising device for a guitar string according to claim 1 wherein the saddle includes a first passage between the first open bore and a second threaded bore and a second passage from the second threaded bore and the front exterior of the saddle block, such that a guitar string may be fed through the first passage of the saddle block, across the second threaded bore, through the second passage of the saddle block into the first open bore of the saddle block, and the locking screw inserted into the second threaded bore of the saddle block to secure the guitar string between the surface of the locking screw and the surfaces of the first and/or second passage of the saddle block.

3. A saddle block stabilising device for a guitar string according to claim 1 wherein there is included a block insert, the block insert having a generally cylindrical body, the block insert providing the second threaded bore, and the block insert having a collar at one end which has a larger diameter than the generally cylindrical body
the locking screw engaging with the threaded open bore of the block insert,
a lower screw having a cylindrical body with a threaded outer diameter which also cooperates with the second threaded open bore of the block insert
such that the locking screw may be screwed into the block insert, the lower screw screwed into the block insert, and a guitar string fed through the bore of the saddle block and the bore of the block insert the guitar string secured between the end of the upper screw and the end of the lower screw by further screwing the locking screw and/or lower screw into the block insert.

4. A stabilising system for a guitar comprising
a saddle block stabilising device for a guitar string according to claim 1
a headstock stabilising device for a guitar string, the headstock stabilising device comprising;
a base screw, the base screw being generally cylindrical with an axial open bore capable of fitting over a guitar tuning post, and having a cylindrical wall having two generally opposing holes in the cylindrical wall, and having a threaded outer surface;
a body having an open bore which allows the body to fit over the outer diameter of the base screw, the open bore having a threaded inner surface which cooperates with the threaded outer surface of the base screw;
a top comprising an upper cylinder section having a thread on the outer surface and a drive shape on its upper surface, and a lower cylinder section which has a smaller diameter than the upper cylinder section, the upper cylinder section and a lower cylinder sections being concentric, the outer diameter of the upper cylinder section capable of fitting inside the open bore of the body, the thread of the upper cylinder section cooperating with the threaded inner surface of the outer bore of the body;
such that the base screw may be placed over a tuning post of a guitar headstock, a guitar string inserted through the opposing holes in the base screw and a radial bore of the tuning post, the body may be screwed onto the base screw, and the top may be screwed into the body, the top being advanced until the lower cylinder section grips the guitar string against the top of the tuning post and constrains the movement of the guitar string.
